(19) United States
(12) Patent Application Publication
(10) Pub. No.: US 2020/0272894 A1
(43) Pub. Date: Aug. 27, 2020

(54) WEATHER-DEPENDENT PROCESSING OF MULTI-SPECTRAL REFLECTANCE DATA

(71) Applicant: Microsoft Technology Licensing, LLC, Redmond, WA (US)

(72) Inventors: Debasis DAN, Hyderabad (IN); Naresh ANNAM, Hyderabad (IN)

(21) Appl. No.: 16/284,078

(22) Filed: Feb. 25, 2019

(51) Int. Cl. G06N 3/08; G06N 3/063

(52) U.S. Cl. CPC G06N 3/08; G06N 3/063

(57) ABSTRACT

A system includes reception of first multi-spectral reflectance data at a first input of a trained neural network, reception of weather data at a second input of the trained neural network, and generation, using the artificial neural network, of second multi-spectral reflectance data based on the received first multi-spectral reflectance data and the received weather data.

### BACKGROUND

Sunlight falling on an area of land is partially absorbed by the land and partially reflected back toward the sky. The amount of light reflected by an area may be inversely proportional to a density of vegetation in that area. Remote sensors (e.g., satellites, drones) are currently used to capture this reflectance data. Since the intensity of reflection is frequency-dependent, the reflectance data typically includes several (e.g., seven or eight) separate frequency bands, and is therefore referred to as multi-spectral reflectance data.

Multi-spectral reflectance data has many current and potential uses. For example, reflectance data may be used to estimate and forecast crop physiology, phenology, stress, yield, and acreage. The accuracy of such estimates and forecasts is highly dependent on the quality of the reflectance data.

Reflectance data may be noisy due to various atmospheric conditions. Reflectance data may also be incomplete due to blocking of reflected light by clouds or cloud shadows. Anomalous weather patterns can induce anomalous vegetation growth, thereby making a genuine reflectance value appear noisy with respect to the trend. Conventional systems to denoise, correct and impute missing reflectance data apply variations of moving window smoothing. Recently, neural network-based autoencoders have been proposed to remove noise in such sequential feature spaces.

Prescriptive farming is critically dependent on the accuracy of the most-recent points of time-series reflectance data. The previous denoising approaches may be applied to these points, but these approaches typically exacerbate the error near the end of a series due to their tendency to overfit the data. Since the end of the series is of primary importance in the case of prescriptive fanning, approaches for more accurately denoising, imputing and correcting recent reflectance data are desired.

### BRIEF DESCRIPTION OF THE DRAWINGS

FIG. 1 illustrates a system architecture to provide imputed, denoised, and corrected multi-spectral reflectance data according to some embodiments.

FIG. 2 is a flow diagram of a process to provide imputed, denoised, and corrected multi-spectral reflectance data according to some embodiments.

FIG. 3 illustrates generation of ground truth multi-spectral reflectance data according to some embodiments.

FIG. 4 illustrates actual reflectance data and corresponding smoothed reflectance data according to some embodiments.

FIG. 5 illustrates generation of weather feature data according to some embodiments.

FIG. 6 illustrates training of a neural network according to some embodiments.

FIG. 7 illustrates a cloud architecture to provide imputed, denoised, and corrected multi-spectral reflectance data according to some embodiments.

FIG. 8 is a flow diagram of a process to provide agricultural data based on imputed, denoised, and corrected multi-spectral reflectance data according to some embodiments.

FIG. 9 is a block diagram of an apparatus according to some embodiments.

### DETAILED DESCRIPTION

The following description is provided to enable any person in the art to make and use the described embodiments. Various modifications, however, will remain readily-apparent to those in the art.

Generally, some embodiments provide an improved system for denoising, correcting and imputing time-series multi-spectral reflectance data. The improvements may be particularly evident when applied to reflectance data affected by recent weather anomalies such as sustained low temperature, high cloud cover, and sustained low humidity. For example, recent weather anomalies may affect plant growth and thereby affect corresponding recent reflectance data. Conventional systems are unable to distinguish whether the affected reflectance data results from weather, anomalous plant behavior, or another factor, and therefore treat the reflectance data as noise to be smoothed based on prior data.

Embodiments address the foregoing by training an artificial neural network based on input pairs consisting of multi-spectral time-series reflectance data and covariate time-series weather data. The ground truth data used for training may comprise a conventionally-smoothed version of the input multi-spectral time-series reflectance data. According to some embodiments, the training set includes data associated with time periods of anomalous weather which produced anomalous plant growth.

The trained model may operate to remove noise from cloud-free surface reflectance time series data, to impute surface reflectance data for cloud-covered regions, and/or to correct reflectance data distorted by cloud shadows. In some embodiments, the trained model may also predict future reflectance data based on a weather forecast.

The time interval of the reflectance data is typically longer than the time interval of available weather data (e.g., Temp (max, min, avg), precipitation, humidity). Also, the various combinations of weather conditions which create anomalous growth are unknown a priori. Accordingly, some embodiments mask the time-series weather data into multi-channel time series data, where each channel represents a weather “feature” derived from the various types of input weather data and exhibits a time interval matching the time interval of the reflectance data.

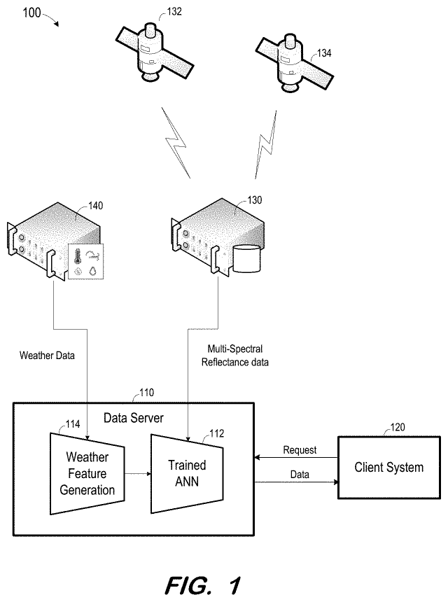

FIG. 1 illustrates system 100 according to some embodiments. Embodiments are not limited to the elements of FIG. 1 or the discussions thereof. System 100 employs a trained artificial neural network to generate multi-spectral reflectance data based on input multi-spectral reflectance data and weather data.

According to the illustrated example, data server 110 receives a request for information relating to multi-spectral reflectance data from client system 120. In response, data server 110 retrieves multi-spectral reflectance data from data provider server 130. The retrieved reflectance data may include data representing several independent frequency bands, e.g., Red, Green, Blue, near-infrared, shortwave, infrared.

Data provider server 130 may be operated by a remote sensing data provider which operates satellites 132 and 134. Data provider server 130 may acquire multi-spectral reflectance data from satellites 132 and 134, perform processing on the data (e.g., instrumentation calibration), and store the data for subsequent provision to requesters such as data server 110.

Satellites 132 and 134 may comprise two satellites of a multi-satellite network operated by the associated data provider. Embodiments may employ any systems for acquiring reflectance data that are or become known. Such systems include but are not limited to drone-based systems. According to some embodiments, and as will be described in detail below, data server 110 may select a reflectance data provider from which to request data from among several reflectance data providers (e.g., Rapid Eye, Sentinel-2, Landsat series, Modis). The selection of a reflectance data provider may be based on the request received from client system 120.

Data server 110 also retrieves weather data from weather data provider 140 based on the request from client system 120. The weather data may include any suitable weather-related metrics, including but not limited to maximum temperature, minimum temperature, average temperature, precipitation, humidity. The retrieved weather data may comprise time-series data for each weather-related metric. As noted herein, the time intervals of the weather data time series may differ from those of the retrieved multi-spectral reflectance data. For example, the satellite network including satellites 132 and 134 may obtain reflectance data for a particular area of land once every 2, 5, or 16 days.

Data server 110 includes trained artificial neural network 112 and weather feature generation network 114. Details of these networks according to some embodiments will be described below. Generally, weather feature generation network 114 generates time-series data of composite weather features based on the received weather data. This time-series data exhibits time intervals which are compatible with the time intervals of the retrieved multi-spectral reflectance time-series data.

Trained artificial neural network 112 generates processed multi-spectral reflectance data based on the weather feature time-series data output by weather feature generation network 114 and the multi-spectral reflectance data retrieved from data provider 130. The processed multi-spectral reflectance data may comprise a denoised, corrected and/or imputed version of the multi-spectral reflectance data retrieved from data provider 130. The accuracy of the most-recent points of the processed multi-spectral reflectance data may be greater than that achievable using conventional systems.

The processed multi-spectral reflectance data may be provided directly to client system 120. In some embodiments, data server 110 further uses the processed multi-spectral reflectance data to determine other data (e.g., soil moisture per region) requested by client system 120.

Each functional component described herein may be implemented in computer hardware (integrated and/or discrete circuit components), in program code and/or in one or more computing systems executing such program code as is known in the art. Such a computing system may include one or more processing units which execute processor-executable program code stored in a memory system. Moreover, data server 110 may comprise hardware and software to implement algorithms generated via neural network training as described below.

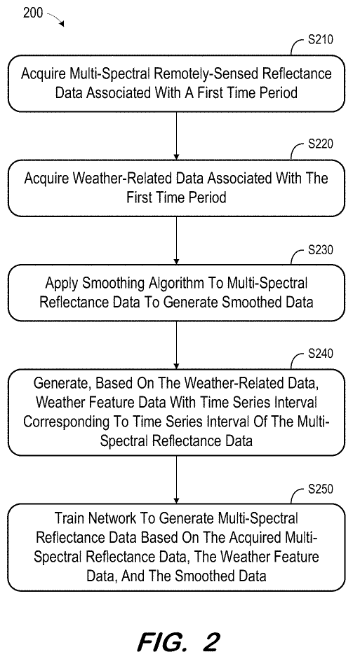

FIG. 2 is a flow diagram of process 200 to train and operate a system according to some embodiments. Process 200 and the other processes described herein may be performed using any suitable combination of hardware, software or manual means. Software program code embodying these processes may be stored by any non-transitory tangible medium, including a fixed disk, a volatile or non-volatile random access memory, a floppy disk, a CD, a DVD, a Flash drive, or a magnetic tape. Embodiments are not limited to the examples described below.

Initially, at S210, remotely-sensed multi-spectral reflectance data is acquired. The acquired data is associated with a first time period and may be acquired in any manner that is or becomes known. The acquired data is time-series data exhibiting a particular time interval (e.g., 2, 5, or 16 days as mentioned above). In some embodiments, the acquired data is historical reflectance data gathered by a reflectance data provider over a statistically-significant period of time. The amount of data acquired may be suitable to train an artificial neural network as described below.

Weather data associated with the first time period is acquired at S220. The weather data may be acquired from one or more weather data providers and comprises time series data for each of several weather-related metrics (e.g., daily maximum temperature). According to some embodiments, the first time period includes periods of anomalous weather and/or anomalous plant growth in order to better train a network to process reflectance data acquired during such phenomena.

Flags or other weather-related information may be determined at S220 based on the acquired weather data and used to supplement the weather data. For example, if in a given day the difference between the minimum and maximum temperature is less than a given threshold (e.g., 3.6 degrees C.) and the amount of precipitation is greater than 1 mm, the day may be flagged as a cloudy day within the weather data.

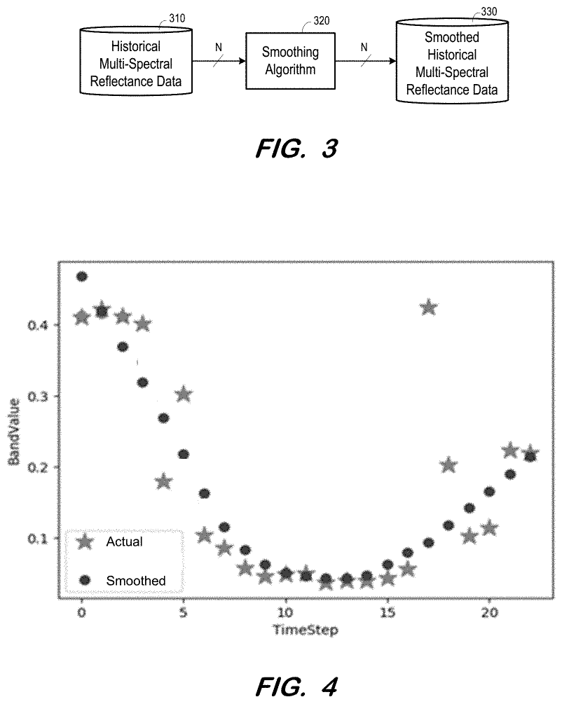

Next, at S230, a smoothing algorithm is applied to the data received at S210. Any suitable algorithm that is or becomes known may be employed at S230. FIG. 3 illustrates generation of smoothed data at S230 according to some embodiments. Historical multi-spectral reflectance data 310 represents data acquired at S210 and including N spectral bands. Data 310 is subjected to smoothing algorithm 320 (e.g., a smoothing computer program executed by a computing device) to generate smoothed ihstorical multi-spectral reflectance data 330. In some embodiments, the LOESS (Locally-weighted scattering smoothing) method is used to smooth the data at S230. The smoothed data will serve as a proxy for actual “ground truth” data in the subsequently-described network training.

FIG. 4 is a chart illustrating actual reflectance data (e.g., historical multi-spectral reflectance data 310) for one spectral band and smoothed data generated based thereon at S230. As shown, smoothing at S230 may correct, denoise and impute missing data.

Weather feature data is generated at S240 based on the weather data acquired at S220. As described above, the weather feature data generated at S240 may comprise time-series data having a time interval corresponding to the time interval of the acquired time-series reflectance data acquired at S210.

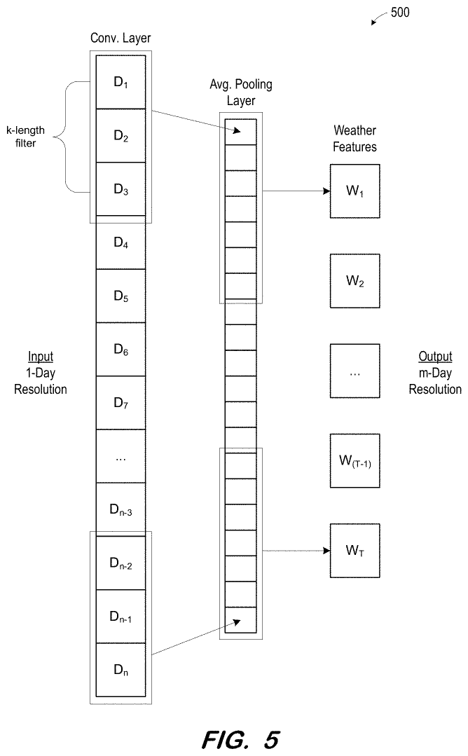

FIG. 5 is a diagram of a system to generate weather features from input weather data at S240 according to some embodiments. System 500 is a one-dimensional convolutional neural network with filter and kernel lengths selected to match the frequency of the acquired reflectance data. In the illustrated example, the input weather data consists of metrics having 1-day resolution (embodiments may employ other temporal resolutions), and is pooled to create composite weather features having an m-day resolution and which are derivative features of the weather data metrics.

A network is trained at S250 to generate multi-spectral reflectance data. The training is based on the multi-spectral reflectance data acquired at S210, the weather feature data generated at S240 and the smoothed data generated at S230. The network may comprise any one or more artificial neural network architectures that are or become known, trained in any suitable manner.

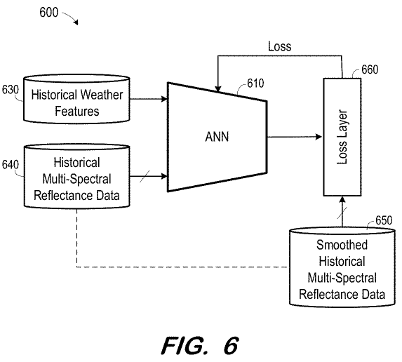

FIG. 6 illustrates architecture 600 for training a network 610 at S250 according to some embodiments. Network 610 may comprise a variation of a Long Short Term Memory (LSTM) autoencoder decoder for short time series. Network 610 may consist of an input layer, two recurrent hidden layers and an output layer. Since the input data is time-series data, LSTM hidden units may be used within the hidden layers. For example, at a time step t, LSTM includes dedicated memory blocks beside hidden unit hₜ.

A memory block contains gates that manage the block's state and output. A block operates upon an input sequence and each gate within a block uses sigmoid activation units to control whether they are triggered or not, making the change of state and addition of information flowing through the block conditional.

There are three types of gates in a block, a forget gate, an input gate, and an output gate. A forget gate conditionally decides what information to throw away from the block, an input gate conditionally decides which input values are used to update the memory state, and an output gate conditionally decides what to output based on the input values and the memory of the block. Each block acts as a state machine in which the weights of its gates are learned during training.

As shown, network 610 is trained by inputting historical weather features 630 and historical multi-spectral reflectance data 640 and by comparing the output to smoother historical multi-spectral reflectance data 650. Features 630 may have been generated at S240 based on data acquired at S220. Similarly, data 640 may have been acquired at S210 and smoothed data 650 may have been generated at S230.

Training of network 610 involves determining a loss based on the output of network 610 and iteratively modifying network 610 based on the loss until the loss reaches an acceptable level or training otherwise terminates. Loss layer component 660 determines the loss by comparing reflectance data generated by network 610 to “ground truth” data 650. The loss may comprise an L1 loss, and L2 loss, or any other suitable measure of total loss.

The determined loss is back-propagated to network 610 and used to modify network 610 as is known in the art. The modification may comprise modification of weights associated with internal nodes of network 610. The process repeats until the total loss is acceptable, at which point network 610 is considered trained.

According to some embodiments, the historical weather data acquired at S220, rather than the weather features data, is input to network 610 during training. In such embodiments, network 610 may include an input network such as system 500 to receive this weather data and to generate weather features therefrom for input to the remainder of network 610. During training, the nodes of the input network are trained along with the other nodes of network 610.

Architecture 600 may be implemented by a computing system to facilitate the design and training of an artificial neural network. The computing system may comprise a standalone system, or one or more elements of the computing system may be located in the cloud. Such a computing system may execute program code of a training program to perform the training operations described above, and which utilizes a library of program code to execute various network node operations. The system may also execute code to facilitate the definition of the nodes and layers of network 610.

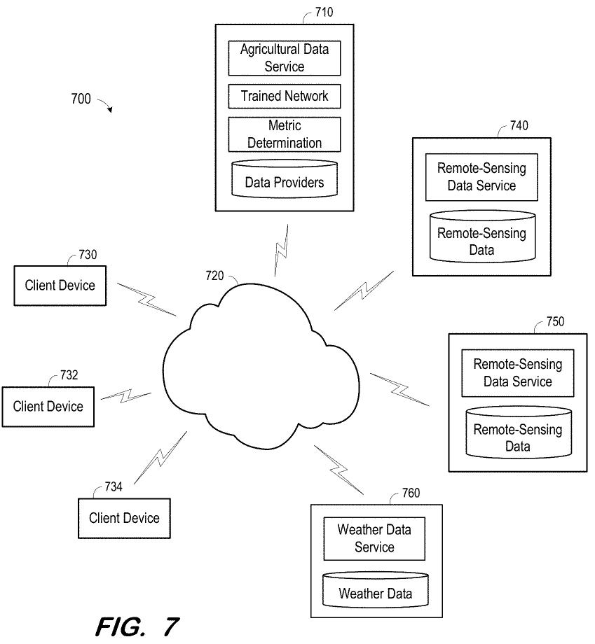

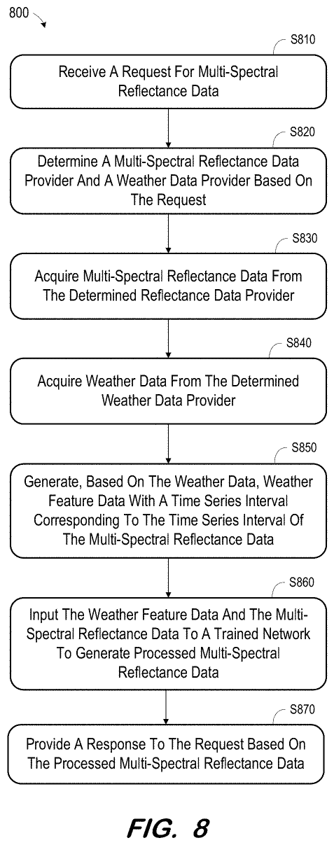

FIG. 7 illustrates distributed system 700 according to some embodiments. System 700 may be cloud-based and the various components thereof may be implemented using on-demand virtual machines, virtual servers and cloud storage instances.

As shown, data server 710 may be implemented as a.cloud service providing agricultural data. Data server 710 may access services of other cloud-based or on-premise data servers 740, 750 and 760. In particular, data servers 740 and 750 may provide multi-spectral reflectance data and data server 760 may provide weather data, each of which may be used as described above to generate multi-spectral reflectance data. Data server 710 may store data associated with each of data providers 740, 750 and 760 which specifies the type, granularity, and coverage of data provided by each data provider. The data may also include account codes, costs, and any other information which might be useful in selecting a data provider from which to request data in response to a request received from a client.

FIG. 8 illustrates process 800 which may be executed by data server 710 in response to such a request. Initially, a request for multi-spectral reflectance data is received at S810. The request may be received from one of client devices 730, 732 and 734. In one example, a user operates device 730 to request agricultural data from an agricultural data service executing on data server 710. The request may comprise a Hypertext Transfer Protocol (HTTP) request issued from a Web Browser executing on client device 730 and specifying an Internet Protocol address of a Web Server associated with data server 710.

The request may comprise a request for specific reflectance data associated with a specific location, specific time period and a particular sensor (e.g., satellite) network. In some embodiments, the request may also or alternatively request values of one or more metrics which may be calculated based on multi-spectral reflectance data. For example, the request may request soil moisture values for one or more locations over a particular time period. The time period associated with the request may include a recent time period, for which some embodiments provide more accurate reflectance data (and metric values computed therefrom) than existing systems.

Based on the request, a multi-spectral reflectance data provider and a weather data provider are determined at 5820. The providers are determined based on the type of data needed to fulfill the request, the frequency of the data, the location or locations associated with the request, and any other suitable factors. In this regard, data server 710 stores information describing the data provided by one or more data providers. The information may also include data used to request data from each data provider.

At S830, multi-spectral reflectance data needed to fulfill the request is acquired from the determined reflectance data provider. Similarly, weather data needed to fulfill the request is acquired from the deteimined weather data provider at S840. Weather feature data having a time interval corresponding to the time interval of the acquired reflectance data is generated at S850. As described above, S850 may occur internally to a trained network including weather data input layers such as those shown in FIG. 5. In this regard, the weather feature data (or the acquired weather data) is input along with the acquired reflectance data to a trained network at S860 to generate processed multi-spectral reflectance data. Data server 710 may execute program code implementing the trained network to generate the processed multi-spectral reflectance data at S860. The code may implement convolution kernels or other data structures exported by system 600 after training of network 610.

A response to the request is provided at S870 based on the processed multi-spectral reflectance data. The response may simply include the processed multi-spectral reflectance data, or may include a metric determined based on the processed multi-spectral reflectance data. In the former case, the client may use the processed multi-spectral reflectance data to calculate one or more metrics.

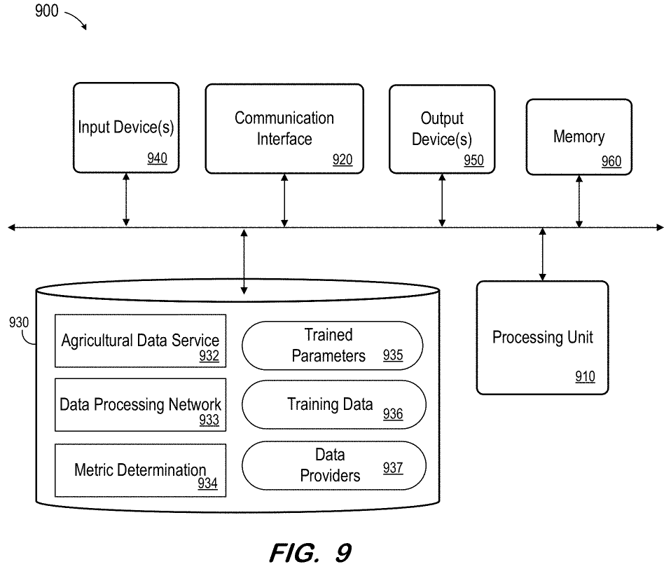

FIG. 9 is a block diagram of system 900 according to some embodiments. System 900 may comprise a general-purpose computer and may execute program code to perform any of the functions described herein. For example, system 900 may comprise an implementation of data server 110 and/or 710 in some embodiments.

System 900 includes processing unit 910 operatively coupled to communication device 920, persistent data storage system 930, one or more input devices 940, one or more output devices 950 and volatile memory 960. Processing unit 910 may comprise one or more processors, processing cores, etc. for executing program code. Communication interface 920 may facilitate communication with external devices, such as client devices, and data providers as described herein. Input device(s) 940 may comprise, for example, a keyboard, a keypad, a mouse or other pointing device, a microphone, a touch screen, and/or an eye-tracking device. Output device(s) 950 may comprise, for example, a display (e.g., a display screen), a speaker, and/or a printer.

Data storage system 930 may comprise any number of appropriate persistent storage devices, including combinations of magnetic storage devices (e.g., magnetic tape, hard disk drives and flash memory), optical storage devices, Read Only Memory (ROM) devices, etc. Memory 960 may comprise Random Access Memory (RAM), Storage Class Memory (SCM) or any other fast-access memory.

Agricultural data service 932, data processing network 933 and metric determination 934 may comprise program code executed by processing unit 910 to cause system 900 to receive and respond to requests from client devices, to generate reflectance data, and to calculate metric values based on generated reflectance data, respectively, as described herein. The code of data processing network 933 may utilize trained parameters 935, which may be trained based on training data 936. Data providers 937 stores information associated with providers of multi-spectral reflectance data and weather data. Data storage device 930 may also store data and other program code for providing additional functionality and/or which are necessary for operation of system 900, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions.

Embodiments described herein are solely for the purpose of illustration. Those in the art will recognize other embodiments may be practiced with modifications and alterations to that described above.

What is claimed is:

1. A system comprising:
a memory comprising executable program code; and
a processing unit to execute the program code to:
receive first multi-spectral reflectance data;
receive weather data;
input the first multi-spectral reflectance data and the weather data to an artificial neural network:
generate, using the artificial neural network, second multi-spectral reflectance data based on the received first multi-spectral reflectance data and the received weather data.

2. A system according to claim 1, the processing unit to execute the program code to train the artificial neural network based on historical multi-spectral reflectance data, historical weather data and on a smoothed version of the historical multi-spectral reflectance data.

3. A system according to claim 2, wherein training of the artificial neural network comprises:
generation, using the artificial neural network, of intermediate multi-spectral reflectance data based on the historical multi-spectral reflectance data and the historical weather data;
comparison of the intermediate multi-spectral reflectance data with the smoothed version of the historical multi-spectral reflectance data; and
modifying the artificial neural network based on the comparison.

4. A system according to claim 1, wherein generation of the second multi-spectral reflectance data comprises:
generation of weather feature data based on the weather data; and
generation of the second multi-spectral reflectance data based on the received first multi-spectral reflectance data and the weather feature data.

5. A system according to claim 4, wherein a time series interval of the weather feature data is different from a time-series interval of the weather data

6. A system according to claim 1, the processing unit to execute the program code to:
receive a request from a client device;
select one of two or more reflectance data providers based on request; and
receive the first multi-spectral reflectance data from the selected provider.

7. A system according to claim 6, wherein the request includes a metric, and wherein the processing unit is to execute the program code to:
determine a value of the metric based on the second multi-spectral reflectance data; and
transmit the value to the client device.

8. A method comprising:
receiving first multi-spectral reflectance data at a first input of a trained neural network;
receiving weather data at a second input of the trained neural network;
generating, using the artificial neural network, second multi-spectral reflectance data based on the received first multi-spectral reflectance data and the received weather data.

9. A method according to claim 8, further comprising:
receiving historical multi-spectral reflectance data associated with a first time period and historical weather data associated with the first time period;
applying a smoothing algorithm to the historical multi-spectral reflectance data to generate smoothed historical multi-spectral reflectance data; and
training the neural network based on the historical multi-spectral reflectance data, the historical weather data and the smoothed historical multi-spectral reflectance data.

10. A method according to 9, wherein training the neural network comprises:
generation, using the artificial neural network, intermediate multi-spectral reflectance data based on the historical multi-spectral reflectance data and the historical weather data;
comparing the intermediate multi-spectral reflectance data with the smoothed historical multi-spectral reflectance data; and
modifying the neural network based on the comparison.

11. A method according to claim 8, wherein generating the second multi-spectral reflectance data comprises:
generating weather feature data based on the weather data; and
generating the second multi-spectral reflectance data based on the received first multi-spectral reflectance data and the weather feature data.

12. A method according to claim 11, wherein a time series interval of the weather feature data is different from a time-series interval of the weather data

13. A method according to claim 8, further comprising:
receiving a request from a client device;
selecting one of two or more reflectance data providers based on request; and
receiving the first multi-spectral reflectance data from the selected provider.

14. A method according to claim 13, wherein the request includes a metric, and the method further comprising:
determining a value of the metric based on the second multi-spectral reflectance data; and
transmitting the value to the client device.

15. A system comprising:
an artificial neural network comprising:
an input layer to receive first multi-spectral time-series reflectance data associated with a first time interval and time-series weather data of a plurality of weather-related metrics, the time-series weather data associated with a second time interval;
a convolutional layer to receive the time-series weather data and to output time-series weather feature data associated with the first time interval; and
an output layer to output second multi-spectral reflectance data.

16. A system according to claim 15, wherein the artificial neural network is trained based on historical multi-spectral reflectance data, historical weather data and on a smoothed version of the historical multi-spectral reflectance data.

17. A system according to claim 16, wherein training of the artificial neural network comprises:
generation, using the artificial neural network, of intermediate multi-spectral reflectance data based on the historical multi-spectral reflectance data and the historical weather data;
comparison of the intermediate multi-spectral reflectance data with the smoothed version of the historical multi-spectral reflectance data; and
modifying the artificial neural network based on the comparison.

18. A system according to claim 15, further comprising:
a data server to:
receive a request from a client device;
select one of two or more reflectance data providers based on request; and
receive the first multi-spectral time-series reflectance data from the selected provider.

19. A system according to claim 18, wherein the request includes a metric, and wherein the data server is further to:
determine a value of the metric based on the second multi-spectral time-series reflectance data; and
transmit the value to the client device.
